(19) United States
(12) Patent Application Publication
(10) Pub. No.: US 2007/0061480 A1
(43) Pub. Date: Mar. 15, 2007

(54) Method and apparatus for forwarding a data stream through a distribution proxy server

(76) Inventor: Eric C. Scoredos, Boulder Creek, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/227,839

(22) Filed: Sep. 14, 2005

(51) Int. Cl. G06F 15/16

(52) U.S. Cl. 709/231

(57) ABSTRACT

A method and apparatus for forwarding a datastream by receiving a datastream from a streaming media server, determining a list of one or more receivers, receiving a portion of the datastream into a kernel space and directing from the kernel space a portion of the datastream to one or more communications connections established with one or more receivers.

### BACKGROUND

Distribution of entertainment, information, audio programming, audio-video programming and other forms of content has entered a brave new dimension. In a simpler age, content was distributed using traditional broadcasting techniques. In a broadcast model, content is disseminated to a large audience without first needing to be addressed to a particular recipient (i.e. a receiver). Content was simply introduced into a distribution medium that conveyed the content to a large number of receivers. In order to receive a content stream, a receiver merely needed to select a content stream, for example by tuning to a particular radio frequency.

In the realm of computer networking, dissemination of streaming content was to be the be-all-to-end-all distribution mechanism. Of course, like with any brave new vision, problems, immediately began to arise. The first and most discouraging problem with Internet delivery was that of managing the availability of the medium. This is not a new problem. In the traditional broadcast realm, this problem was addressed by licensing radio frequency spectrum so that a particular broadcaster could enjoy a geographically exclusive right to use a particular broadcast channel.

In the networking realm, the problem is a little more complicated. First, the Internet (and other wide area networking structures) can not simply broadcast a content stream. If this were to be allowed, data packets would flood the backbone and every nook and cranny of the Internet. If such broadcasting were allowed, a particular receiver could simply look for data packets from a particular source address in order to receive a content stream. This, though, would also require a receiver to receive each and every broadcast data packet so that a selection of data packets according to a source address could be made.

In order to overcome this basic problem, streaming media is delivered over a network by establishing media streams from a specific media content server to a specific receiver. As such, a communications connection between the media content server and the receiver is established and used to convey individual data packets included in a content stream. By so doing, a stream of media content does not need to permeate the entire Internet. Rather, a receiver makes a request for a content stream and the content stream is then addressed to the receiver. It can well be appreciated that this is a significant departure from the traditional broadcast model.

In order to improve efficiency, a new protocol scheme was developed where a single datastream is directed to a plurality of receivers. This protocol is known as the IP multicast protocol. In a multicast protocol, a single data packet is directed from a single source address to a common destination address. One or more receivers then register to receive IP data packets at that multicast address. The Internet multicast routing protocols ensure that packets are sent only to registered receivers. However, IP multicast can create many data paths in a large, geographically dispersed network.

### BRIEF DESCRIPTION OF THE DRAWINGS

Several alternative embodiments will hereinafter be described in conjunction with the appended drawings and figures, wherein like numerals denote like elements, and in which:

FIG. 1 is a pictorial diagram that depicts various illustrative use cases for a system for forwarding a datastream;

FIG. 2 is a flow diagram that depicts one example method for forwarding a datastream;

FIG. 3 is a flow diagram that depicts alternative methods for receiving a datastream;

FIG. 4 is a flow diagram that depicts a variation of the present method where a datastream is received by means of a connection established with a server;

FIG. 5 is a flow diagram that depicts one example method for determining a list of one or more receivers, wherein a receiver is privy to the presence of a media proxy server;

FIG. 6 is a flow diagram that depicts an example method for determining a list of one or more receivers wherein a streaming media server (or other data streaming server) directs a streaming media proxy to forward a datastream to a particular receiver;

FIG. 7 is a flow diagram that depicts an example method for directing a portion of a datastream to a receiver using hypertext transfer protocol packets;

FIG. 8 is a flow diagram that depicts a general method for directing a portion of a datastream from a kernel space to a receiver;

FIG. 9 is a flow diagram that depicts alternative example methods for opening a communications channel with a receiver;

FIG. 10 is a block diagram that depicts several alternative example embodiments of a system for forwarding a data stream;

FIG. 11 is a data flow diagram that depicts the internal operation of various alternative example embodiments of a datastream forwarding system;

FIG. 12 is a pictorial representation of one example embodiment of a receiver list; and

FIG. 13 is a pictorial representation of a process for encapsulating a portion of a datastream into a protocol data packet.

### DETAILED DESCRIPTION

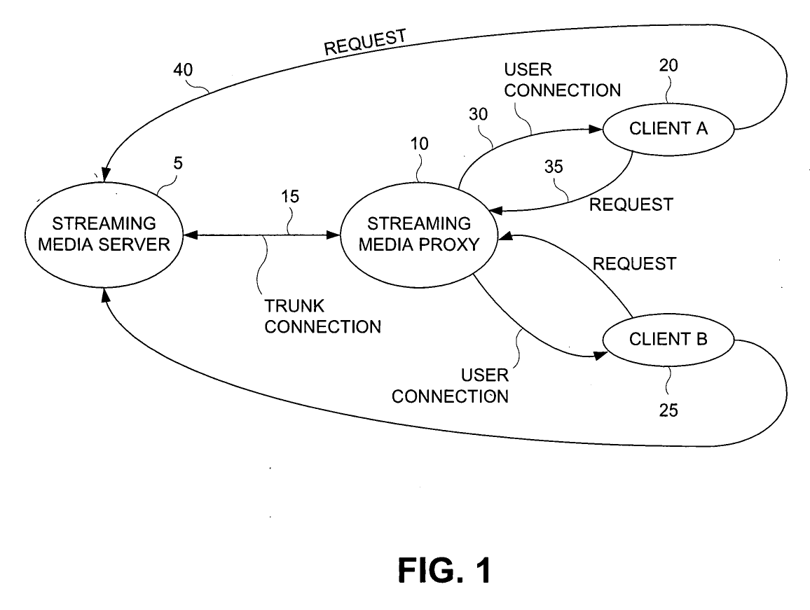

FIG. 1 is a pictorial diagram that depicts various illustrative use cases for a system for forwarding a datastream. It should be appreciated that the various illustrative use cases presented in this figure are intended to illustrate various applications for a method and apparatus, as herein described, for forwarding a datastream. Accordingly, these illustrative use cases are not intended to limit the scope of the claims appended hereto. According to one illustrative use case, a datastream, for example a media content stream, is received from a streaming media server 5. The streaming media server 5 establishes a trunk connection 15 with a streaming media proxy 10. The streaming media proxy 10, according to this illustrative use case, forwards a datastream received by means of the trunk connection 15 to one or more clients users (client A 20, client B 25). In this way, various switches and routers can replicate the data packet and cause it to flow specifically to only those branches of the network where the intended (i.e. addressed) receivers are located.

It should be appreciated that in the normal course of data streaming, a client (20, 25) requests delivery of a datastream directly from a streaming media server 5. In such an ordinary course of data streaming, the streaming media server 5 establishes a connection directly with the client (20, 25) and then provides a datastream directly to the client. According to the present method, the streaming media server 5 provides a datastream to the streaming media proxy 10, which in turn forwards the datastream to a particular client (20, 25).

According to one illustrative use case, a particular client (20, 25) is privy to the existence of the streaming media proxy 10. In this situation, a particular client (20, 25) directs a request 35 directly to the streaming media proxy 10. In response, the streaming media proxy 10 establishes a user connection 30 with a particular client 20 and then directs a datastream to the client 20 using the user connection. It should be appreciated that the user connection 30, according to various illustrative use cases, comprises a point-to-point communications connection. Such a point-to-point communications connection, according to one variation of the present method, is carried by a communications protocol such as the Transmission Control Protocol/Internet protocol (TCP/IP). Any suitable protocol can be used and the claims appended hereto are not intended to be limited to applications where TCP/IP is used.

According to yet another illustrative use case, a particular client (20, 25) is not necessarily privy to the streaming media proxy 10. In this situation, a particular client 20 directs a requests 40 to streaming media server 5. Accordingly, the streaming media server will then identify a particular streaming media proxy 10, which will be used to forward a datastream to the requesting client 20. The streaming media server then directs the streaming media proxy 10 to establish a user connection 30 with the requesting client. The streaming media proxy 10 then forwards a datastream to the client 20 using the established user connection 30.

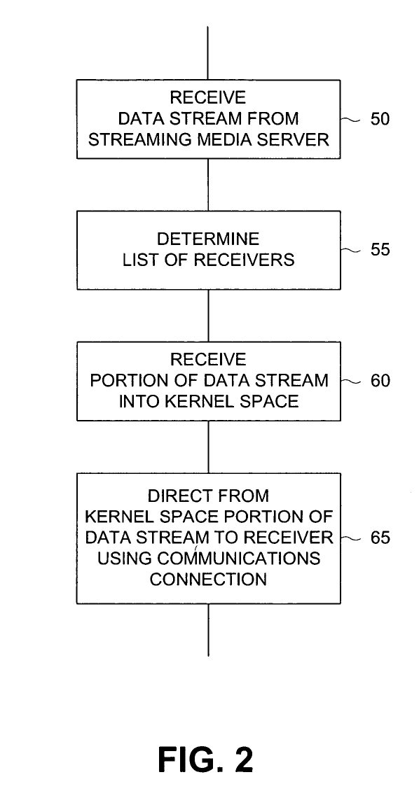

FIG. 2 is a flow diagram that depicts one example method for forwarding a datastream. According to this example method, the datastream is forwarded by receiving a datastream from a server (step 50). According to one variation of the present method, the datastream is received from a streaming media server. The present method then provides for determining a list of one or more receivers (step 55). A portion of a datastream, which is received from a server, is stored in a kernel space (step 60). According to the list of one or more receivers, a portion of a datastream is then directed from the kernel space to a receiver using a communications connection established with the receiver (step 65). It should be appreciated that, according to one illustrative use case, the present method is implemented in a computing platform. As such, a computing platform includes a memory which is apportioned amongst various processes executing in the computing platform. Such memory is partitioned amongst user processes and operating system processes. Operating system processes are allowed access to a portion of memory known as “kernel space”.

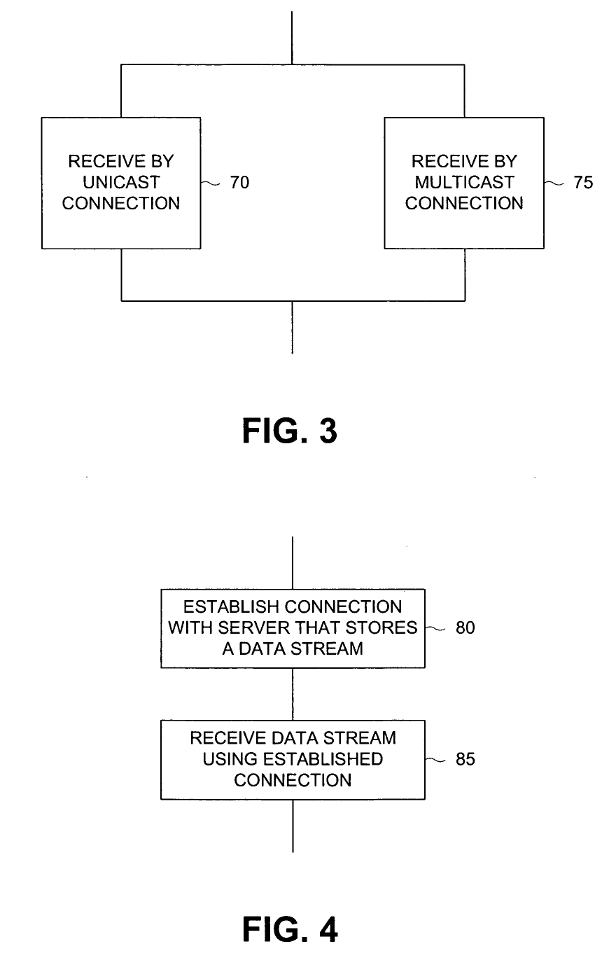

FIG. 3 is a flow diagram that depicts alternative methods for receiving a datastream. According to one illustrative variation of the present method, a datastream is received from a streaming media server 5 (or other data streaming server) by means of a unicast connection (step 70). It should be appreciated that a unicast datastream is typically supported by extensions to a protocol such as TCP/IP. In a unicast datastream, a datastream is directed to a specific destination address which, according to one illustrative use case, corresponds to a streaming media proxy 10. According to yet another illustrative variation of the present method, a datastream is received from a streaming media server 5 (or other data streaming server) by means of a multicast connection (step 75). It should likewise be appreciated that a multicast connection is typically supported by extensions to a protocol such as TCP/IP. In a multicast connection, a datastream is directed by the multicast routing protocols to a particular destination address and one or more streaming media proxies 10 receive a content stream according to the destination address. It should likewise be appreciated that the present method may be applied in situations where multiple streaming media proxies 10 are used in conjunction with a single streaming media server 5. It should also be appreciated that the present method may be applied where a trunk connection 15 comprises either a unicast connection to each individual streaming media proxy 10 or a multicast connection that two or more streaming media proxies 10 may use to receive a datastream.

FIG. 4 is a flow diagram that depicts a variation of the present method where a datastream is received by means of a connection established with a server. It should be appreciated that the present method, according to this example variation, provides for establishing a communications connection with a server (step 80). The communications connection established with a server is then used to receive a datastream which is stored on the server (step 85). As such, the scope of the claims appended hereto is not intended to be limited to any particular mechanism by which the datastream is received from a datastream server or a streaming media server 5.

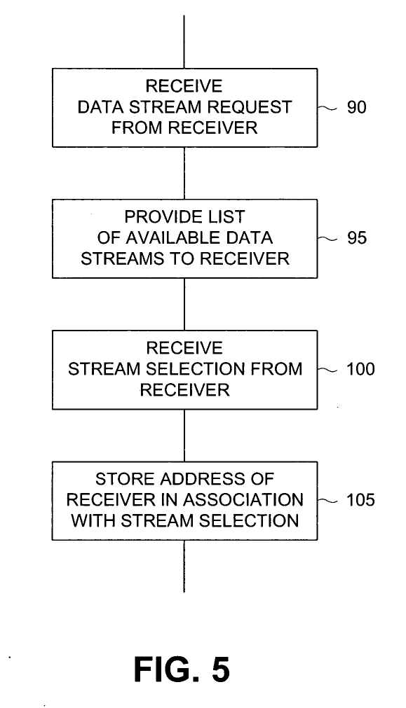

FIG. 5 is a flow diagram that depicts one example method for determining a list of one or more receivers wherein a receiver is privy to the presence of a media proxy server. According to this illustrative variation of the present method, a list of one or more receivers is determined by receiving a datastream request from the receiver (step 90). In this variation of the present method, a list of available datastreams is then provided to the receiver (step 95). It should be appreciated that this interaction, according to yet another illustrative variation of the present method, provides for relaying a datastream by means of a communications connection established between a receiver (20, 25) and a streaming media proxy 10. Based upon the list of available datastreams provided to the receiver, the receiver directs a stream selection to the streaming media proxy. Once the stream selection is received from the receiver (step 100), the address of the receiver is stored in a list of one or more receivers (step 105). It should likewise be appreciated that the address of a receiver is associated with the stream selection, which is also received from the receiver.

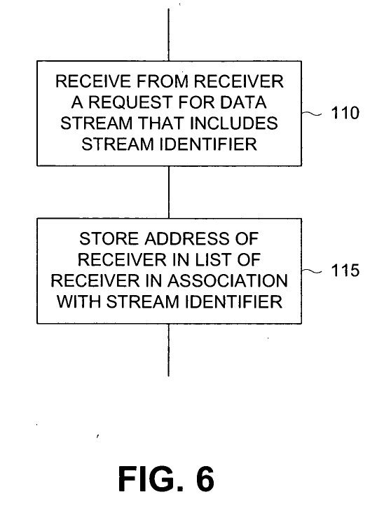

FIG. 6 is a flow diagram that depicts an example method for determining a list of one or more receivers wherein a streaming media server (or other data streaming server) directs a streaming media proxy to forward a datastream to a particular receiver. According to this variation of the present method, which is applicable to situations where a streaming media server receives a request for a datastream directly from a particular receiver as heretofore described, a list of one or more receivers is determined by receiving a request for a datastream, where the request includes an address for a receiver and a stream identifier (step 110). The address for the receiver is then stored in a list of one or more receivers along with the stream identifier (step 115). It should be appreciated that the stream identifier and the receiver address are associated with each other when they are stored in the list of one or more receivers.

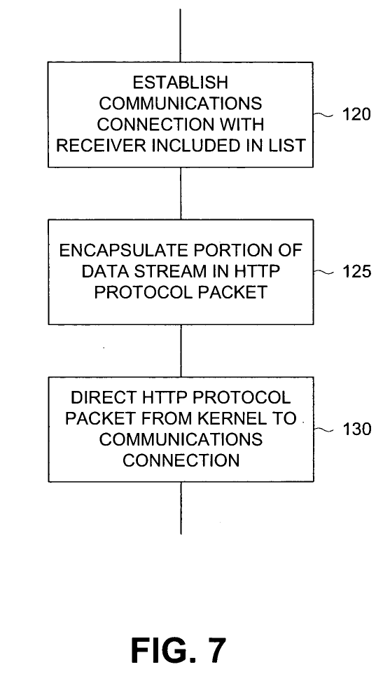

FIG. 7 is a flow diagram that depicts an example method for directing a portion of a datastream to a receiver using hypertext transfer protocol packets. According to this example variation of the present method, directing from the kernel space a portion of the datastream to a communications connection is accomplished by establishing a communications connection with the receiver included in a list of one or more receivers (step 120). A portion of a received datastream, which according to this variation of the present method, is stored in a kernel space and is encapsulated in a hypertext transfer protocol packet (step 125). It should be appreciated that the hypertext transfer protocol packet is also created in and stored in the kernel portion of the memory. The hypertext transfer protocol packet is then directed from kernel space to the established communications connection (step 130), thereby directing the hypertext transfer protocol (HTTP) data packet to a receiver. It should also be appreciated that the hypertext transfer protocol data packet is typically carried by a TCP/IP data packet. Accordingly, the TCP/IP data packet is also managed in the kernel space before the TCP/IP data packet carrying the hypertext transfer protocol data packet is directed to a communications connection established with a receiver. It should be appreciated that a single encapsulated portion of a datastream, according to yet another variation of the present method, is directed to a plurality of communications connections, obviating the need to create multiple copies of a data packet for multiple corresponding communications channels.

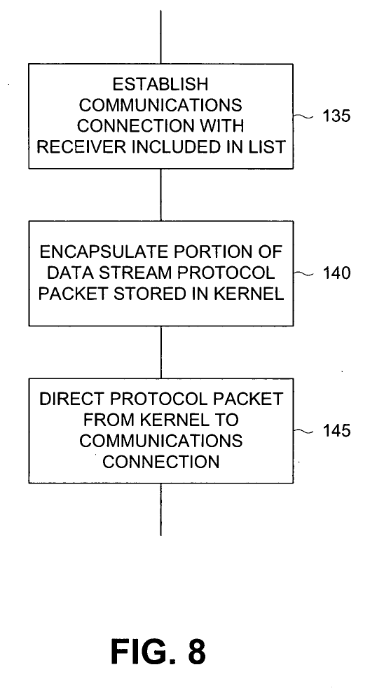

FIG. 8 is a flow diagram that depicts a general method for directing a portion of a datastream from kernel space to a receiver. It should be appreciated that, according to this variation of the present method, a communications connection is established with a particular receiver (step 135). It should be appreciated that, according to yet another variation of the present method, a communications connection is established using a protocol including, but not limited to TCP/IP. In this variation of the present method, a portion of the datastream, which is stored in the kernel, is then encapsulated in a protocol data packet (step 140). It should likewise be appreciated that the protocol data packet is created in and stored in the kernel space. According to this variation of the present method, the protocol data packet stored in the kernel space is then directed to the established communications connection (step 145). It should be appreciated that any suitable protocol can be used and the scope of the claims appended hereto is not intended to be limited to the use of TCP/IP as a protocol for directing a datastream from kernel space to a receiver. It should be appreciated that a single encapsulated portion of a datastream, according to yet another variation of the present method, is directed to a plurality of communications connections obviating the need to create multiple copies of a data packet for multiple corresponding communications channels.

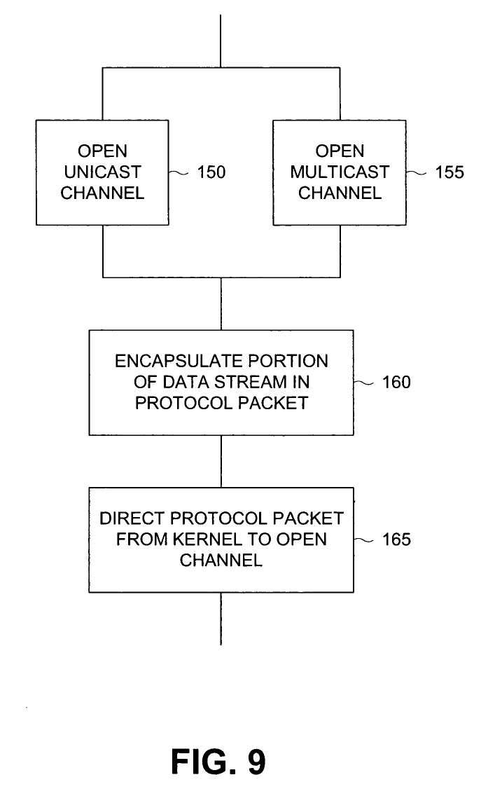

FIG. 9 is a flow diagram that depicts alternative example methods for opening a communications channel with a receiver. It should be appreciated that, according to one variation of the present method, a portion of a datastream stored in the kernel space is directed to a receiver by opening a communications connection with a receiver included in a list of one or more receivers. Opening a communications connection with the receiver, according to one example variation of the present method, is accomplished by opening a unicast channel directed to a particular receiver (step 150). In an alternative example method, a multicast channel is opened (step 155). In the case where a multicast channel is opened, such multicast channel is typically used to service a plurality of receivers. Accordingly, as additional receivers are added, each newly added receiver is made aware of the multicast channel so that the newly added receiver can receive a content stream from the multicast channel. The portion of a datastream stored in kernel space is then encapsulated in a protocol data packet (step 160). The data packet is then directed from kernel space to an opened channel (step 165). It should be appreciated that a single encapsulated portion of a datastream, according to yet another variation of the present method, is directed to a plurality of opened channels, obviating the need to create multiple copies of a data packet for multiple corresponding communications channels.

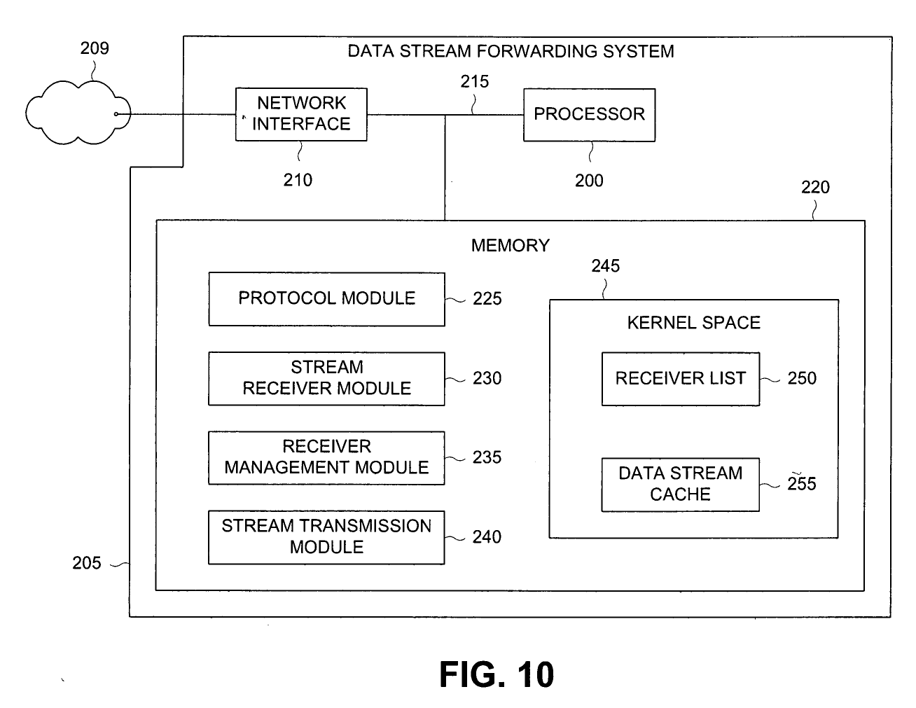

FIG. 10 is a block diagram that depicts several alternative example embodiments of a system for forwarding a data stream. According to one example embodiment, a system for forwarding a datastream 205 comprises a memory 220, one or more processors 200, a network interface 210 and one or more instruction sequences stored in the memory 220. In operation, the memory 220 is used to store kernel data in a kernel portion 245 of the memory 220 and instruction sequences in an instruction sequence portion of the memory. The processor 200 executes the one or more instruction sequences stored in the memory. The network interface 210 enables the processor 200 to communicate with a data network 209. Any form of data network, including a wide area network and a local area network, may be utilized for communicating with a process external to the system and is intended to facilitate forwarding a datastream from a server to a client process. It should also be appreciated that all of the afore-described elements are communicatively associated with each other by means of a bus 215.

Also included in various example alternative embodiments of the system are one or more functional modules. A functional module is typically embodied as an instruction sequence. An instruction sequence that implements a functional module, according to one alternative embodiment, is stored in the memory 220. The reader is advised that the term “minimally causes the processor” and variants thereof is intended to serve as an open-ended enumeration of functions performed by the processor 200 as it executes a particular functional module (i.e. instruction sequence). As such, an embodiment where a particular functional module causes the processor 200 to perform functions in addition to those defined in the appended claims is to be included in the scope of the claims appended hereto.

The functional modules (i.e. their corresponding instruction sequences) described thus far that enable forwarding a datastream according to the present method are, according to one alternative embodiment, imparted onto computer readable medium. Examples of such medium include, but are not limited to, random access memory, read-only memory (ROM), compact disk ROM (CD ROM), floppy disks, hard disk drives, magnetic tape and digital versatile disks (DVD). Such computer readable medium, which alone or in combination can constitute a stand-alone product, can be used to convert a general-purpose computing platform into a device capable of forwarding a datastream according to the techniques and teachings presented herein. Accordingly, the claims appended hereto are to include such computer readable medium imparted with such instruction sequences that enable execution of the present method and all of the teachings herein described.

According to one example embodiment, a system for forwarding a datastream 205 further comprises a stream receiver module 230, a receiver management module 235 and a stream transmission module 240. According to this example embodiment, each of these modules comprises an instruction sequences that is stored in the memory 220. According to this example embodiment, a kernel space portion 245 of the memory 220 is used to store a datastream cache 255. The kernel space portion 245 of the memory 220 is also used to store a receiver list 250. In one alternative example embodiment, the datastream forwarding system 205 further comprises a protocol module 225 that is also stored in the memory 220. It should be appreciated that the various instruction sequences described herein are stored in an instruction sequence portion of the memory 220.

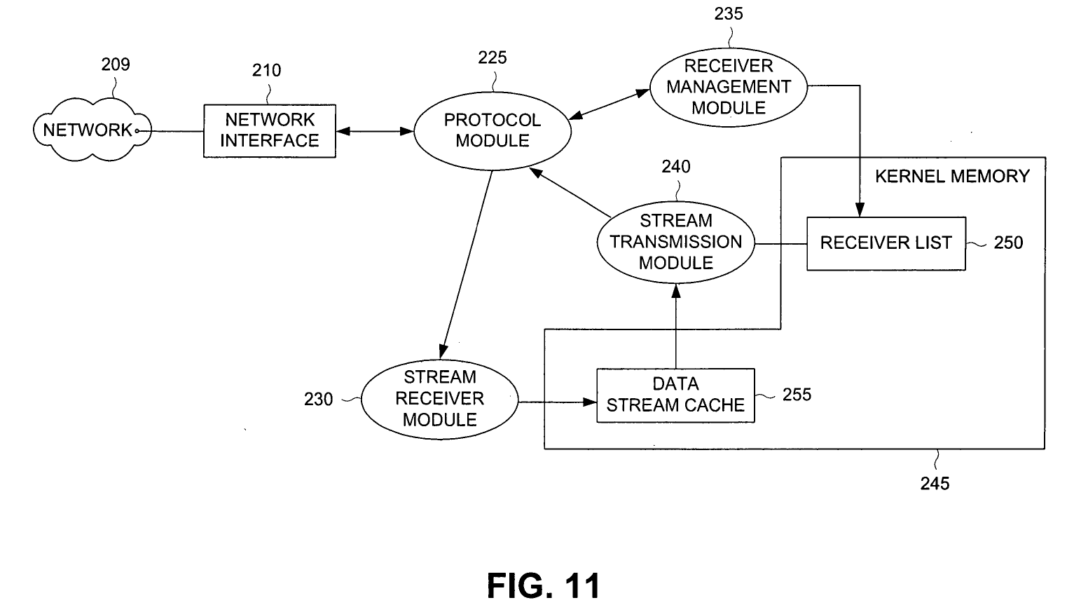

FIG. 11 is a data flow diagram that depicts the internal operation of various alternative example embodiments of a datastream forwarding system. According to one example embodiment, the stream receiver module 230, when executed by the processor 200, minimally causes the processor to receive from the network interface 210 a datastream and then store the datastream in the datastream cache 255. It should be appreciated that the datastream cache 255 is maintained by the processor 200 in a kernel portion 245 of the memory 220. In this alternative example embodiment, the receiver management module 235, when executed by the processor 200, minimally causes the processor to determine a list of receivers to which a received datastream is to be forwarded. In one alternative example embodiment, the receiver management module 235 causes the processor to maintain a receiver list 250 in a kernel portion 245 of the memory 220. In this example embodiment, the stream transmission module 240, when executed the processor, minimally causes the processor 200 to direct a datastream that is stored in the kernel portion 245 of the memory 220 to the network interface 210. It should be appreciated that the stream transmission module 240, when executed by the processor 200, minimally causes the processor to retrieve a portion of a datastream stored in the datastream cache 255, which is stored in the kernel portion 245 of the memory 220.

In one alternative example embodiment, the network interface 210 is controlled by the processor 200 as the processor 200 executes a protocol module 225. The protocol module 225, when executed by the processor 200, minimally causes the processor to interact with an executing process in accordance with an established communications protocol. Accordingly, the processor 200 interacts with a process by means of the network interface 210 and establishes a communications connection with a process by means of a data network 209. Such a process, according to one illustrative use case, includes a receiver client process, for example a media player. According to yet another illustrative use case, the process with which a communications connection is established comprises a datastream server (e.g. a streaming media server 5).

FIG. 11 further illustrates that, according to one alternative example embodiment, the protocol module 225, when executed by the processor 200, minimally causes the processor 200 to receive a datastream by means of a unicast channel received by the network interface 210. In yet another alternative example embodiment, the protocol module 225 minimally causes the processor to receive a datastream by means of a multicast channel received by the network interface 210. It should be appreciated that yet another alternative example embodiment of a system for forwarding a datastream 205 includes a protocol module 225 that, when executed by the processor 200, minimally causes the processor 200 to establish a point-to-point communications connection with a datastream server. The stream receiver module 230, when executed by the processor 200, also minimally causes the processor to receive a datastream by means of the established connection and to store the datastream in a kernel portion 245 of the memory 220. It should be appreciated that, according to this alternative example embodiment, the stream receiver module 230 causes the processor 200 to execute the protocol module 225 in order to establish a communications connection with a datastream server.

FIG. 11 further illustrates that, according to yet another illustrative embodiment, the receiver management module 235, when executed by the processor 200, minimally causes the processor to establish a communications connection with a receiver by causing the processor to execute the protocol module 225. Using the established communications connection, the receiver management module 235 directs an enumeration of available datastreams to a receiver. The receiver management module 235 further minimally causes the processor 200 to receive from the establish connection a datastream selection and then store in a list of receivers 250 a destination address for a receiver and the received stream selection. It should be appreciated that the stream selection is typically stored in association with a destination address corresponding to a receiver from whence a stream selection is received. It should also be appreciated that the receiver management module 235 causes the processor 200 to respond to a receiver's request for an enumeration of available data streams by directing said enumeration of available data streams to a communications channel established with the receiver.

In yet another example alternative embodiment, the receiver management module 235 causes the processor 200 to establish a connection with a datastream server by executing the protocol module 225. The receiver management module 235 further minimally causes the processor 200 to receive a destination address for a receiver and a datastream identifier by means of the communications connection established with a datastream server. The receiver management module 235 then causes the processor 200 to store in a list of receivers 250 the received destination address and the received stream identifier. It should be appreciated that the stream identifier received from the datastream server is stored in association with the destination address received from the datastream server.

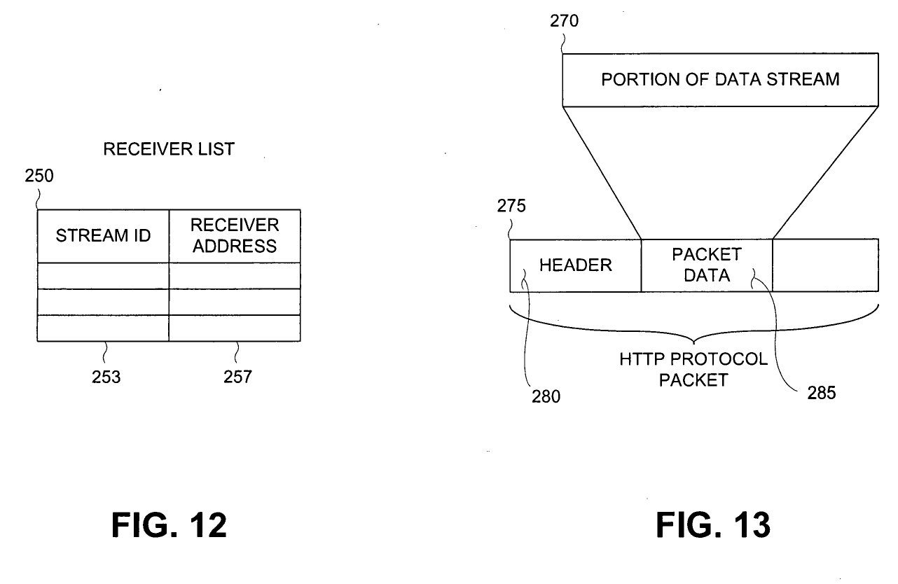

FIG. 12 is a pictorial representation of one example embodiment of a receiver list. According to one alternative example embodiment, the receiver list 250, which is stored in a kernel portion 245 of the memory 220, comprises one or more records. According to this example embodiment, a record stored in the receiver list 250 includes a stream identifier (ID) field 253 and a receiver address field 257. Accordingly, the stream identifier is stored in the stream identifier field 253 together with a destination receiver address, which is stored in the receiver address field 257. It should be appreciated that a stream identifier and a receiver address are associated with each other when thy are stored together in a single record in the receiver list 250.

FIG. 13 is a pictorial representation of a process for encapsulating a portion of a datastream into a protocol data packet. According to one example embodiment, the stream transmission module 240 causes the processor 200 to encapsulate a portion of a data stream, which is stored in a kernel portion 245 of the memory 220, in protocol data packet 275. In one alternative example embodiment, the stream transmission module 240 causes the processor to store a portion of a datastream 270 in a hypertext protocol packet. In either of these example embodiments, a protocol data packet (or a hypertext transfer protocol packet) 275 includes a header 280, which identifies the type of data packet prepared by the processor 200 as it executes the stream transmission module 240. It should be appreciated that, according to one alternative example embodiment, the processor 200 encapsulates a portion of a datastream 270 in a data packet 275 by executing portions of a protocol module 225. The protocol module 225, according to this alternative example embodiment, provides facilities for encapsulating data in a protocol packet.

FIG. 11 further illustrates that, according to another alternative example embodiment, the stream transmission module 240, when executed by the processor 200, minimally causes the processor 200 to establish a connection with a receiver according to a destination address retrieved from the receiver list 250 stored in a kernel portion 245 of the memory 220. The stream transmission module 240 further minimally causes the processor to prepare a portion of a datastream stored in a kernel portion of the memory 245 for conveyance to the receiver with which a communications connection is established. It should be appreciated that the stream transmission module 240 causes the processor to establish a communications connection with the receiver by causing the processor to execute the protocol module 225. The stream transmission module 240 selects a particular datastream stored in a kernel portion of the memory according to a stream identifier retrieved from the receiver list 250. A portion of a selected datastream is then encapsulated in a hypertext transfer protocol packet and directed from the kernel portion 245 of the memory to the connection established with the receiver. In yet another alternative example embodiment, stream transmission module 240 causes the processor to encapsulate a portion of a selected stream in a protocol data packet, which is not necessarily a hypertext transfer protocol packet. In this alternative example embodiment, the protocol data packet includes, but is not limited to a Transmission Control Protocol/Internet Protocol data packet.

It should be appreciated that, according to various alternative example embodiments, the stream transmission module 240 causes the processor to direct the protocol module 225 to establish a point-to-point connection with a receiving process, which is subsequently used as a communications connection to convey to a receiver a portion of a datastream stored in the datastream cache 255. In yet another alternative example embodiment, the stream transmission module 240 causes the processor to direct the protocol module 225 to establish at least one of a unicast data channel and a multicast data channel, either of which may be used to convey a portion of a datastream from the datastream cache 255 stored in a kernel portion 245 of the memory to a receiver as the processor 200 continues to execute the protocol module 225.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for forwarding a datastream comprising:
receiving a datastream from a streaming media server;
determining a list of one or more receivers;
receiving a portion of the datastream into kernel space; and
directing from the kernel space the portion of the datastream to one or more communications connections established with one or more receivers.

2. The method of claim 1 wherein receiving a datastream comprises receiving at least one of a unicast datastream and a multicast data stream.

3. The method of claim 1 wherein receiving a datastream comprises:
establishing a communication connection with a server that stores a data stream; and
receiving a datastream by means of the established connection.

4. The method of claim 1 wherein determining a list of one or more receivers comprises:
receiving from a receiver a request for a data stream;
providing a list of available data streams to the receiver;
receiving from the receiver a datastream selection; and
storing in association with the stream selection in a list of one or more receivers a destination address for the receiver from whence the request was received.

5. The method of claim 1 wherein determining a list of one or more receivers comprises:
receiving a request for a datastream that includes a stream identifier and a destination address; and
storing in association with the stream identifier in a list of one or more receivers a destination address for the receiver from whence the request was received.

6. The method of claim 1 wherein directing from the kernel space the portion of the datastream to one or more communications connections established with a receiver comprises:
establishing a communications connection with a receiver included in the list of one or more receivers;
encapsulating a portion of the datastream in a hyper-text transport protocol packet stored in the kernel; and
directing the hyper-text transport protocol packet from the kernel to the communication connection.

7. The method of claim 1 wherein directing from the kernel space the portion of the datastream to one or more communications connections established with a receiver comprises:
establishing a communications connection with a receiver included in the list of one or more receivers;
encapsulating a portion of the datastream in a protocol packet stored in the kernel; and
directing the protocol packet from the kernel to the communication connection.

8. The method of claim 1 wherein directing from the kernel space the portion of the datastream to one or more communications connections established with a receiver comprises:
opening a communications connection with a receiver included in the list of one or more receivers;
encapsulating a portion of the datastream in a protocol packet stored in the kernel; and
directing the protocol packet from the kernel to the communication connection, wherein the communications connection includes at least one of a unicast data channel and a multicast data channel.

9. A system for forwarding a datastream comprising:
memory for storing kernel data and one or more instruction sequences;
processor for executing an instruction sequence stored in the memory;
network interface for communicating with a data network; and
one or more instruction sequences stored in the memory including:
stream receiver module that, when executed by the processor, minimally causes the processor to receiver from the network interface a datastream and store the datastream in a kernel portion of the memory;
receiver management module that, when executed by the processor, minimally causes the processor to determine a list of receivers to which a received datastream is to be forwarded to; and
stream transmission module that, when executed by the processor, minimally causes the processor to direct a portion of a datastream stored in the kernel portion of the memory to one or more receivers as specified in the list of receivers using the network interface.

10. The system of claim 9 wherein the stream receiver module causes the processor to receive a datastream by minimally causing the processor to receive a datastream from at least one of a unicast channel received by the network interface and a multicast channel received by the network interface.

11. The system of claim 9 further comprising a protocol module that, when executed by the processor, minimally causes the processor to establish a communication connection with a process by means of the network interface and wherein the stream receiver module causes the processor to:
establish a communication connection with a datastream server process by executing the protocol module;
receive a datastream by means of the established connection; and
store the datastream in a kernel portion of the memory.

12. The system of claim 9 further comprising a protocol module that, when executed by the processor, minimally causes the processor to establish a communication connection with a process by means of the network interface and wherein the receiver management module causes the processor to:
establish a communication connection with a receiver by executing the protocol module;
direct to the established communication connection an enumeration of available data streams;
receive from the established connection a datastream selection; and
store in a list of receivers a destination address for a receiver and a stream selection, said stream selection being stored in association with the destination address.

13. The system of claim 9 further comprising a protocol module that, when executed by the processor, minimally causes the processor to establish a communication connection with a process by means of the network interface and wherein the receiver management module causes the processor to:
establish a communication connection with a datastream server by executing the protocol module;
receive from the established connection a destination address for a receiver and a datastream identifier; and
store in a list of receivers the received destination address for a receiver and the received stream identifier, said stream identifier being stored in association with the destination address.

14. The system of claim 9 further comprising a protocol module that, when executed by the processor, minimally causes the processor to establish a communication connection with a process by means of the network interface and wherein the stream transmission module causes the processor to:
establish a connection with a receiver included in a list of one or more receivers;
encapsulate a portion of a datastream stored in a kernel portion of the memory in a hyper-text transport protocol packet; and
direct the hyper-text transport protocol packet to a connection established with a receiver.

15. The system of claim 9 further comprising a protocol module that, when executed by the processor, minimally causes the processor to establish a communication connection with a process by means of the network interface and wherein the stream transmission module causes the processor to:
establish a connection with a receiver included in a list of one or more receivers;
encapsulate a portion of a datastream stored in a kernel portion of the memory in a protocol packet, wherein the protocol packet is also stored in the kernel portion of the memory; and
direct the protocol packet from the kernel portion of the memory to a connection established with a receiver.

16. The system of claim 9 further comprising a protocol module that, when executed by the processor, minimally causes the processor to establish a communication connection with a process by means of the network interface and wherein the stream transmission module causes the processor to:
establish a connection with a receiver included in a list of one or more receivers;
encapsulate a portion of a datastream stored in a kernel portion of the memory in a protocol packet, wherein the protocol packet is also stored in the kernel portion of the memory; and
direct the protocol packet from the kernel portion of the memory to a connection established with a receiver, wherein the communications connection comprises at least one of a unicast data channel and a multicast data channel.

17. A computer readable medium having imparted thereon one or more instruction sequences for forwarding a datastream including:
stream receiver module that, when executed by a processor, minimally causes a processor to receiver from a network interface a datastream and store a datastream in a kernel portion of a memory;
receiver management module that, when executed by a processor, minimally causes a processor to determine a list of receivers to which a received datastream is to be forwarded to; and
stream transmission module that, when executed by a processor, minimally causes a processor to direct a portion of a datastream stored in the kernel portion of the memory to one or more receivers as specified in a list of receivers using the network interface.

18. The computer readable medium of claim 17 wherein the stream receiver module causes a processor to receive a datastream by minimally causing the processor to receive a datastream from at least one of a unicast channel received by a network interface and a multicast channel received by a network interface.

19. The computer readable medium of claim 17 further comprising a protocol module that, when executed by the processor, minimally causes a processor to establish a communication connection with a process by means of a network interface and wherein the stream receiver module causes a processor to:
establish a communication connection with a datastream server process by executing the protocol module;
receive a datastream by means of an established connection; and
store a portion of a datastream in a kernel portion of the memory.

20. The computer readable medium of claim 17 further comprising a protocol module that, when executed by a processor, minimally causes a processor to establish a communication connection with a process by means of a network interface and wherein the receiver management module causes the processor to:
establish a communication connection with a receiver by executing the protocol module;
direct to an established communication connection an enumeration of available data streams;
receive from an established connection a datastream selection; and
store in a list of receivers a destination address for a receiver and a stream selection, said stream selection being stored in association with the destination address.

21. The computer readable medium of claim 17 further comprising a protocol module that, when executed by a processor, minimally causes a processor to establish a communication connection with a process by means of the network interface and wherein the receiver management module causes the processor to:
establish a communication connection with a datastream server by executing the protocol module;
receive from an established connection a destination address for a receiver and a datastream identifier; and
store in a list of receivers the received destination address for a receiver and the received stream identifier, said stream identifier being stored in association with the destination address.

22. The computer readable medium of claim 17 further comprising a protocol module that, when executed by a processor, minimally causes a processor to establish a communication connection with a process by means of a network interface and wherein the stream transmission module causes the processor to:
establish a connection with a receiver included in a list of one or more receivers;
encapsulate a portion of a datastream stored in a kernel portion of a memory in a hyper-text transport protocol packet; and
direct the hyper-text transport protocol packet to a connection established with a receiver.

23. The computer readable medium of claim 17 further comprising a protocol module that, when executed by the processor, minimally causes the processor to establish a communication connection with a process by means of the network interface and wherein the stream transmission module causes the processor to:
establish a connection with a receiver included in a list of one or more receivers;
encapsulate a portion of a datastream stored in a kernel portion of a memory in a protocol packet, wherein the protocol packet is also stored in a kernel portion of a memory; and
direct the protocol packet from a kernel portion of a memory to a connection established with a receiver.

24. The computer readable medium of claim 17 further comprising a protocol module that, when executed by a processor, minimally causes a processor to establish a communication connection with a process by means of a network interface and wherein the stream transmission module causes the processor to:
establish a connection with a receiver included in a list of one or more receivers;
encapsulate a portion of a datastream stored in a kernel portion of a memory in a protocol packet, wherein the protocol packet is also stored in a kernel portion of a memory; and
direct the protocol packet from a kernel portion of a memory to a connection established with a receiver, wherein the communications connection comprises at least one of a unicast data channel and a multicast data channel.

25. A system for forwarding a datastream comprising:
means for receiving a datastream from a server;
means for determining a list of one or more receivers;
means for establishing a communications channel with a receiver included in the list of one or more receivers;
means receiving a portion of the datastream into a kernel space; and
means for directing from the kernel space the received portion of the datastream to an established communications connection.
